(19) United States
(12) Patent Application Publication
(10) Pub. No.: US 2015/0169216 A1
(43) Pub. Date: Jun. 18, 2015

(54) METHOD OF CONTROLLING SCREEN OF PORTABLE ELECTRONIC DEVICE

(71) Applicant: Samsung Electronics Co., Ltd., Gyeonggi-do (KR)

(72) Inventor: Youngho Cho, Seoul (KR)

(73) Assignee: Samsung Electronics Co., Ltd.

(21) Appl. No.: 14/570,397

(22) Filed: Dec. 15, 2014

(30) Foreign Application Priority Data
Dec. 13, 2013 (KR) 10-2013-0155302

(51) Int. Cl. G06F 3/0488; G06F 3/01

(52) U.S. Cl. CPC G06F 3/04883; G06F 3/017

(57) ABSTRACT

Disclosed is a method of controlling a screen of a portable electronic device, including detecting touch gestures simultaneously input for a plurality of objects displayed on a touch screen, configuring a plurality of windows based on the detected touch gestures, and displaying function execution screens corresponding to the plurality of objects through the plurality of configured windows.

### PRIORITY

This application claims priority under 35 U.S.C. §119(a) to Korean Patent Application No. 10-2013-0155302, filed in the Korean Intellectual Property Office on Dec. 13, 2013, the contents of which are incorporated herein by reference.

### BACKGROUND OF THE INVENTION

1. Field of the Invention

The present invention relates generally to a method of controlling a screen of a portable electronic device.

2. Description of the Related Art

Due to the prolific development of information communication technologies and semiconductor technologies, the supply and use of various portable electronic devices have rapidly increased. Portable electronic devices provide various functions such as phone call, music reproduction, Short Messaging Service (SMS), digital broadcast reception, short-range wireless communication function, and Internet access.

Portable electronic devices also provide a multi-tasking function which can simultaneously execute a plurality of applications. In order to support the multi-tasking function, the portable electronic devices provide a multi-window function for simultaneously executing a plurality of applications by using a plurality of windows.

In the related art, the multi-window function may be activated when a home button or a cancel button is pressed and held for a period time to execute the multi-window function when one application is executed. As the multi-window function is activated, application icons are displayed within a tray on one side of a screen. By touching a desired icon of the application icons included within the tray and dragging the icon to the currently displayed screen, a user can execute an application corresponding to the icon through a generated window.

As described above, the related art has the inconvenience of requiring a plurality of processes to execute the multi-window function. The window generated through the multi-window function is displayed in a position of the screen regardless of a user's intention or a preset position. Accordingly, there is a need in the art for an improved method of controlling a screen of a portable electronic device which executes a multi-window function.

### SUMMARY OF THE INVENTION

The present invention has been made to address the above problems and disadvantages occurring in the prior art, and to provide at least the advantages set forth below. Accordingly, an aspect of the present invention is to provide a method of controlling a screen of a portable electronic device which executes a multi-window function on a menu screen or an idle screen in which a plurality of icons are displayed through a simple touch gesture and supports the display of multiple windows at desired positions.

In accordance with an aspect of the present invention, a method of controlling a screen of a portable electronic device includes detecting touch gestures simultaneously input for a plurality of objects displayed on a touch screen, configuring a plurality of windows based on the detected touch gestures, and displaying function execution screens corresponding to the plurality of objects through the plurality of configured windows.

In accordance with another aspect of the present invention, a portable electronic device includes a touch screen configured to display a plurality of objects and to detect touch gestures simultaneously input for the plurality of objects, and a controller configured to detect the touch gestures input into the touch screen, to configure a plurality of windows based on the detected touch gestures, and to control the touch screen to display function execution screens corresponding to the plurality of objects through the plurality of configured windows.

### BRIEF DESCRIPTION OF THE DRAWINGS

The above and other aspects, features and advantages of the present invention will be more apparent from the following detailed description in conjunction with the accompanying drawings, in which:

FIG. 1 is a block diagram illustrating a configuration of a portable electronic device according to an embodiment of the present invention;

FIG. 2 is a flowchart illustrating a method of controlling a screen of a portable electronic device according to an embodiment of the present invention;

FIG. 3 illustrates a method of executing a multi-window function according to an embodiment of the present invention;

FIG. 4 is a flowchart illustrating the method of executing the multi-window function according to another embodiment of the present invention;

FIGS. 5A and 5B illustrate a method of executing a multi-window function according to another embodiment of the present invention;

FIG. 6 is a flowchart illustrating the method of executing the multi-window function according to another embodiment of the present invention;

FIG. 7 illustrates a method of executing a multi-window function according to another embodiment of the present invention;

FIG. 8 illustrates multi-window switching according to an embodiment of the present invention; and

FIG. 9 illustrates a multi-window movement by a rotation of a portable electronic device according to an embodiment of the present invention.

### DETAILED DESCRIPTION OF EMBODIMENTS OF THE INVENTION

Embodiments of the present invention will now be described in detail with reference to the accompanying drawings. It should be noted that the same elements will be designated by the same reference numerals although they are shown in different drawings. A detailed description of known functions and configurations incorporated herein will be omitted for the sake of clarity and conciseness. Herein, the term “object” may be a drawing or a symbol, which is displayed to select a particular function or data on a screen of a portable electronic device, including an icon of an application, an item, and an image.

The term “multi-touch gesture” may indicate touching two or more points on a touch screen. In other words, when multiple touches are simultaneously input or when a gesture of performing one touch and then another touch is input within a preset time, the gesture may be determined as a multi-touch gesture.

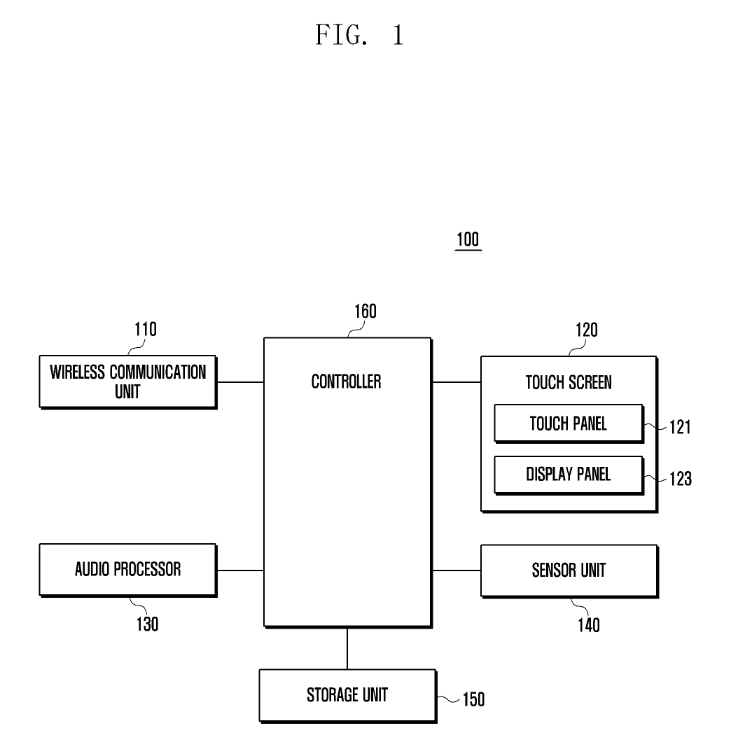

FIG. 1 is a block diagram illustrating a configuration of a portable electronic device 100 according to an embodiment of the present invention.

Referring to FIG. 1, the portable electronic device 100 can include a wireless communication unit 110, a touch screen 120, an audio processor 130, a sensor unit 140, a storage unit 150, and a controller 160.

The wireless communication unit 110 is a component which can be added when the portable electronic device 100 supports a communication function and may be omitted when the portable electronic device 100 does not support the communication function. The wireless communication unit 110 can form a communication channel of a preset scheme with a network (mobile communication network) which can be supported under a control of the controller 160 to transmit/receive a signal related to wireless communication such as voice communication or video communication, and message service-based data communication such as SMS, a Multimedia Messaging Service (MMS), or the Internet.

The wireless communication unit 110 can include a transceiver (not shown) for up-converting and amplifying a frequency of a transmitted signal, and low-noise amplifying and down-converting a frequency of a received signal. The wireless communication unit 110 can form a data communication channel for a message service to transmit/receive message service-based data under a control of the controller 160. The communication channel can include a mobile communication channel of Code Division Multiple Access (CDMA), Time Division Multiple Access (TDMA), or Orthogonal Frequency-Division Multiple Access (OFDMA) and an Internet communication channel of a wired or wireless Internet network.

The touch screen 120 can provide various screens required for operation of the portable electronic device 100. For example, the touch screen 120 may support an idle screen, a menu screen, and an application execution screen required for the operation of the portable electronic device 100. The touch screen 120 can include a touch panel 121 and a display panel 123. The touch panel 121 may be implemented in an add-on type located on the display panel 123 or an in-cell type inserted into the display panel 123.

The touch panel 121 can generate a touch event in response to a user's touch gesture for the screen, can perform an Analog to Digital (AD) conversion on the touch event, and can transmit the touch event to the controller 160. The touch panel 121 may be a complex touch panel 121 including a hand touch panel configured to detect a hand touch gesture and a pen touch panel configured to detect a pen touch gesture. The hand touch panel may be implemented in a capacitive type, a resistive type, an infrared type, or an acoustic wave type.

The touch panel 121 can transmit coordinates included in a touch area (that is, an area touched by a user's finger or an electronic pen) to the controller 160 and can determine at least one of the coordinates included in the touch area of the screen 120 as a touch coordinate. The controller 160 can detect a user's touch gesture based on change in continuously received touch coordinates and an intensity of the touch event. For example, the controller 160 may detect a touch position, a touch movement distance, a touch movement direction, and a touch speed from the touch event. The touch gesture can include touch-down, touch and drag, and flick according to a form or a change of the touch coordinate.

The touch-down refers to an action of touching one position of the touch panel 121 by a user's finger and then removing the finger from the screen, the touch and drag refers to an action of moving a finger in a particular direction at a predetermined speed while maintaining the touch on the one position and then removing the finger from another position at which the movement ends, and the flick refers to an action of rapidly moving a finger in a flicking motion and then removing the finger from the screen. When the coordinate changes as the touch event is generated from the touch panel 121, the controller 160 can determine that there is a movement of the finger and can recognize the type of user gesture based on a change in an intensity of the touch event. When the user's touch gesture is the touch and drag or the flick, the controller 160 can determine a position where the finger starts the movement and a movement direction.

The multi-touch gesture may refer to an action of touching two or more positions on the touch screen 120. In other words, when multiple touches are simultaneously input or when a gesture of performing one touch and then another touch is input within a preset time, the gesture may be determined as the multi-touch gesture.

The touch panel 121 according to an embodiment of the present invention can detect the multi-touch gesture for an execution of the multi-window function by the user. More specifically, the touch panel 121 can detect the multi-touch gesture for a plurality of objects when an idle screen, a menu screen, or an application execution screen including a plurality of objects is displayed, and can transmit the detected multi-touch gesture to the controller 160. The multi-touch gesture may be at least one of multi-touch, multi-long tap, multi-drag, and multi-flick. In another embodiment of the present invention, the touch panel 121 can detect a drag or a multi-drag for simultaneously or sequentially moving a plurality of objects to a particular area in which the multi-window function is executed.

The display panel 123 can display data on the screen under a control of the controller 160. For example, when the controller 160 processes data (for example, decodes data) and stores the data in a buffer, the display panel 123 can convert the data stored in the buffer to an analog signal and display the converted data on the screen. The display panel 123 can display various screens according to the use of the portable electronic device 100, such as a lock screen, a home screen, an application execution screen, a menu screen, a keypad screen, a message writing screen, and an Internet screen.

The display panel 123 can display function execution screens corresponding to a plurality of objects through two or more windows, that is, the multi-window based on touch gestures for the plurality of objects displayed on the touch screen 120 under a control of the controller 160. In an embodiment of the present invention, the touch panel 123 may configure multiple windows based on the multi-touch gesture for a plurality of detected objects when an idle screen, a menu screen, and an application execution screen including the plurality of objects are displayed on the touch screen 120 and display a function execution screen corresponding to each of the plurality of objects through each of the configured multiple windows under control of the controller 160. The multi-touch gesture may be a touch or long-tap action for the plurality of objects displayed on the touch screen 120.

In another embodiment of the present invention, the display panel 123 may place multiple windows in positions on the touch screen 120 which are determined according to a change in position of the detected multi-touch gesture and display a function execution screen corresponding to each of a plurality of objects on each of the multiple windows under a control of the controller 160. More specifically, the display panel 123 can display a function execution screen corresponding to each of a plurality of objects on multiple windows of which placement positions are determined according to a position changed of a touch drag or flick action for the plurality of objects, for example, a drag or flick direction when an idle screen, a menu screen, and an application execution screen including the plurality of objects are displayed on the touch screen 120 under a control of the controller 160.

In another embodiment of the present invention, when a plurality of objects are sequentially or simultaneously moved as a result of a user's touch gesture and a function execution input mapped to a particular area is received when a screen including the particular area in which the multi-window function is executed is displayed, the display panel 123 can display a function execution screen corresponding to the plurality of objects on each of the multiple windows.

The display panel 123 can display a separator (not shown) for separating the multiple windows under a control of the controller 160. For example, when the multiple windows are configured by two windows, the display panel 123 can display one separator between the two windows to separate the two windows from each other. When the multiple windows are configured by three windows, the display panel 123 can display two separators among the three windows to separate the three windows from each other. However, the separator of the present invention is not limited thereto, and separators corresponding to the number of windows included in the multiple windows may be displayed. The separator may not only separate the multiple windows but also control a size of each of the multiple windows.

The display panel 123 may be implemented by a Liquid Crystal Display (LCD), an Active Matrix Organic Light Emitted Diode (AMOLED), a Passive Matrix Organic Light Emitted Diode (PMOLED), a flexible display, or a transparent display.

The audio processor 130 can include a codec (not shown), and the codec can include a data codec for processing packet data and an audio codec for processing an audio signal such as a voice. The audio processor 130 can convert a digital audio signal to an analog audio signal through the audio codec, output the analog audio signal through a receiver (RCV) or a speaker (SPK), convert an analog signal input from a microphone (MIC) to a digital audio signal through the audio codec. The audio processor 130 according to an embodiment of the present invention may output an effect sound according to the operation of the portable electronic device 100 through the SPK. For example, the audio processor 130 may output an effect sound for informing of selection of a plurality of objects by the multi-touch gesture or an effect sound for informing of execution of multiple windows through the SPK.

The sensor unit 140 can collect sensor information for supporting a rotation function of the portable electronic device 100. The sensor unit 140 may be configured by a sensor which can detect rotation of the portable electronic device 100, such as an acceleration sensor. The sensor unit 140 can generate sensor information when the portable electronic device 100 is placed in a particular direction or a direction of the portable electronic device 100 is changed when the portable electronic device 100 is placed in a particular direction. The generated sensor information is transmitted to the controller 160 and used as data for determining a placement state of the portable electronic device 100.

The sensor unit 140 can include at least one of various sensors such as a geomagnetic sensor, a gyro sensor and an acceleration sensor. The sensor unit 140 can be activated when a particular user function is activated and detect a rotation of the portable electronic device 100.

The storage unit 150 is a secondary memory unit of the controller 160 and may include a disk, a Random Access Memory (RAM), and a flash memory. The storage unit 150 can store data generated by the portable electronic device 100 or data received from external devices, such as a server or a desktop Personal Computer (PC), through the wireless communication unit 110 or an external interface unit (not shown) under a control of the controller 160. The storage unit 150 can store various types of data, such as moving image, game, music, movie, and map data. The storage unit 150 according to an embodiment of the present invention stores a multi-window operating program by a multi-gesture.

The multi-window operating program can include a routine that displays a function execution screen corresponding to each of a plurality of objects through two or more windows, that is, multiple windows based on a touch gesture for the plurality of objects displayed on the touch screen 120, a routine for switching between the multiple windows when the function execution screens are displayed through the multiple windows, and a routine for controlling position movements of the multiple windows according to a rotation state (or a placement state) of the portable electronic device 100. The routine that displays the function execution screen corresponding to each of the plurality of objects through the multiple windows based on the touch gesture for the plurality of objects displayed on the touch screen 120 can include a sub routine that displays a function execution screen corresponding to each of a plurality of objects through multiple windows by a multi-touch, a multi-touch drag, or a flick and execution of functions mapped to a particular area including a plurality of moved objects.

The controller 160 can control general operations of the portable electronic device 100 and a signal flow between internal components of the portable electronic device 100, and perform a function of processing data. For example, the controller 160 may be configured by a Central Processing Unit (CPU), an Application Processor (AP), a single core processor or a multi-core processor.

In an embodiment of the present invention, the controller 160 can display a function execution screen corresponding to each of a plurality of objects through each of multiple windows based on a multi-touch gesture for the plurality of objects displayed on the touch screen 120. More specifically, the controller 160 can receive a multi-touch event such as a multi-touch or a multi-long tap for a plurality of objects displayed on the touch screen 120 from the touch panel 121, and control the display panel 123 to display a function executions screen corresponding to each of the plurality of objects through each of the multiple windows.

The controller 160 may configure the number of multiple windows corresponding to the number of multiple objects. For example, when a multi-touch gesture for three objects is detected, the controller 160 may configure three windows and control the display panel 123 to display function execution screens corresponding to the three objects through the three windows. The controller 160 may receive information on a placement state of the portable electronic device 100 from the sensor unit 140 and configure multiple windows according to the placement state. For example, when the portable electronic device 100 faces a forward direction relative to the user's face and is horizontally placed on the ground, the controller 160 may configure multiple windows which are vertically split on the touch screen 120. However, the configuration of the multiple windows is only an example, and does not limit the scope of the present invention.

Accordingly, the controller 160 can control the multiple windows to be configured according to a predetermined user setting regardless of the placement state of the portable electronic device 100. For example, when the portable electronic device 100 faces a forward direction relative to the user's face (e.g., facing the same direction as the user's face is facing) and is horizontally placed on the ground, the controller 160 may configure multiple windows which are vertically split from the touch screen 120.

When screens in which functions corresponding to a plurality of objects are executed through multiple windows are displayed, the controller 160 can control the display panel 123 to display separators for separating the multiple windows and controlling sizes of the multiple windows. For example, when the multiple windows are configured by two windows, the controller 160 can control the display panel 123 to display one separator between the two windows to separate the two windows. The controller 160 can detect a touch gesture for the separator, for example, a touch drag gesture for the separator and control each of sizes of the multiple windows according to a direction of the touch drag.

When screens in which functions corresponding to a plurality of objects are executed through the multiple windows are displayed, the controller 160 can detect a multi-touch gesture and switch positions of the multiple windows. More specifically, when the multiple windows are configured by a plurality of windows including a first window and a second window, the controller 160 can detect a multi-touch gesture for the screen displayed through the first window and the second window. The controller 160 may switch positions of the first window and the second window based on the detected touch gesture.

The multi-touch gesture may be multiple touches for the first window and the second window. The multi-touch gesture may be a multi-touch drag for the first window and the second window. More specifically, when the multi-touch gesture is a multi-touch drag, the first window is located at an upper part of the touch screen 120, the second window is located at a lower part of the touch screen 120, and when a touch drag for the first window is made in a downward direction and a touch drag for the second window is made in an upward direction, the controller 160 can control the first window to move to the lower part of the touch screen 120 where the second window was located and the second window to move to the upper part of the touch screen 120 where the first window was located. In another embodiment, the controller 160 may switch positions of the multiple windows by a touch gesture for only one of the multiple windows as well as the multi-touch gesture. For example, when the multiple windows are configured by a plurality of windows including a first window and a second window and a touch drag starts at the first window and ends at the second window, the controller 160 can perform a control to switch positions of the first window and the second window.

When function execution screens corresponding to a plurality of objects are displayed on the multiple windows, the controller 160 can perform a control to place each of the multiple windows according to a rotation of the portable electronic device 100. For example, when the portable electronic device 100 is vertically placed in a forward direction relative to the user's face and the multiple windows are placed horizontally with respect to the touch screen 120, when the portable electronic device 100 rotates by 90 degrees, the controller 160 can receive rotation information from the sensor unit 140.

Based on the received rotation information, the controller 160 may vertically split the touch screen 120 and configure multiple windows placed in the split areas. In another embodiment, when the portable electronic device 100 rotates by 180 degrees, the controller 160 can receive rotation information from the sensor unit 140, and place a window which was located at an upper part of the touch screen on a lower part of the touch screen 120 and a window which was located at the lower part of the touch screen 120 on the upper part of the touch screen 120 based on the received rotation information.

In another embodiment of the present invention, the controller 160 can receive a multi-touch event such as a multi-touch drag or a multi-touch flick for a plurality of objects displayed on the touch screen 120 from the touch panel 121 and determine positions of the multiple windows from the received multi-touch event according to movement directions of the drags or flicks for the plurality of objects. When the positions of the multiple windows are determined, the controller 160 can place the multiple windows on the determined positions and control the display panel 123 to display function execution screens corresponding to the plurality of objects through the multiple windows.

For example, when a plurality of objects including a first object and a second object are displayed on the touch screen 120, the controller 160 can detect a multi-touch drag for the first object and the second object. When the first object is dragged towards the upper part of the touch screen 120 and the second object is dragged towards the lower part of the touch screen 120, the controller 160 can control the display panel 123 to display a function execution screen corresponding to the first object through the first window on the upper part of the touch screen 120 and a function execution screen corresponding to the second object through the second window on the lower part of the touch screen 120. In another embodiment, the controller 160 can perform a control to execute the multi-window function according to a placement state of the portable electronic device 100 and a movement direction of the received multi-touch gesture. For example, when the portable electronic device 100 is vertically located in a forward direction relative to the user's face and a plurality of objects including a first object and a second object are displayed on the touch screen 120, the controller 160 can detect a multi-touch drag gesture for the first object and the second object. The controller 160 can perform a control to execute the multi-window function only when a touch drag in a particular preset direction, for example, a direction of the upper part or the lower part of the touch screen 120 is detected. When the multi-touch drag is made on the touch screen 120 in a direction other than the preset direction, the controller 160 can perform a control not to execute the multi-window function.

In another embodiment of the present invention, the controller 160 can control the display panel 123 to output function execution screens corresponding to a plurality of objects through multiple windows by configuring particular areas for the execution of the multi-window function and executing the functions mapped to the particular areas. More specifically, the controller 160 may configure a particular area for executing the multi-window function on one side of the screen currently being displayed. The controller 160 can detect a touch gesture for moving an object displayed on the screen to a particular area. The touch gesture for moving the object to the particular area can include not only a multi-touch gesture simultaneously input for at least two objects, but also a touch drag for one object sequentially input. For example, when a home screen including a first object and a second object is currently displayed on the touch screen 120, the first object and the second object can be moved to particular areas through the multi-touch drag. When the home screen is configured by a plurality of pages, the first object is displayed on a first page of the home screen, and the second object is displayed on a second page of the home screen, the controller 160 can perform a touch drag on the first object to move the first object to a particular area when the first page of the home screen is displayed and perform a touch drag on the second object to move the second object to a particular area when the second page of the home screen is displayed.

When a plurality of objects are located within particular areas, and an input for executing functions mapped to the particular areas, for example, a touch for a particular area is made by the user, the controller 160 can control the display panel 123 to display function execution screens corresponding to the plurality of objects included in the particular areas through the multiple windows.

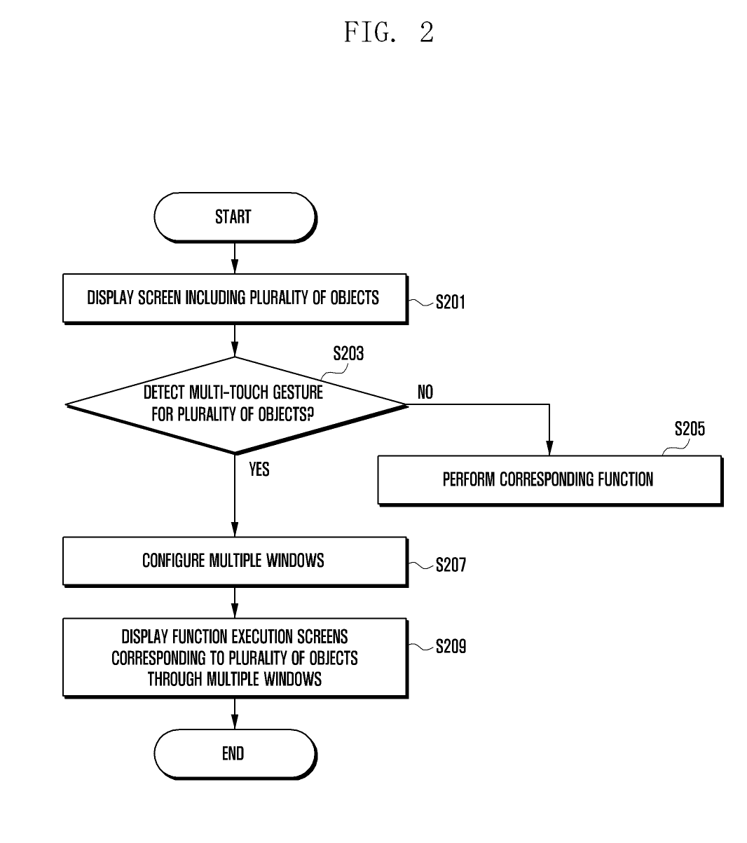

FIG. 2 is a flowchart illustrating a method of controlling a screen of the portable electronic device 100 according to an embodiment of the present invention.

In step S201, the controller 160 can control the display panel 123 to display screens including a plurality of objects. The screen can include a home screen, a menu screen, and an application execution screen including a plurality of objects. The application execution screen may include at least one image such as a picture gallery or a folder including an image or voice file. However, the present invention is not limited thereto and all screens including various images or texts which can be displayed through multiple windows can be applied.

In step S203, the controller 160 can identify whether a multi-touch gesture for a plurality of objects is detected. More specifically, when a multi-touch gesture for a plurality of objects displayed on the touch screen 120 is detected, the controller 160 can receive a multi-touch event from the touch panel 121. The controller 160 can detect the multi-touch gesture from the received multi-touch event. The multi-touch gesture may be a multi-touch or a long-tap for the plurality of objects displayed on the touch screen 120.

When it is identified that the multi-touch gesture for the plurality of objects is not detected in step S203 or when a touch event for executing a function other than the touch event for executing the multi-window function is received, the controller 160 can perform a control to execute a function corresponding to the touch event in step S205. For example, when a touch event for one object is received, the controller 160 can display a screen in which a function corresponding to the one object is executed.

In step S207, the controller 160 can configure multiple windows based on the detected multi-touch gesture. More specifically, the controller 160 can identify the number of a plurality of objects for which the multi-touch gesture is input and configure the number of multiple windows corresponding to the plurality of objects. The controller 160 can receive information on a placement state of the portable electronic device 100 from the sensor unit 140 and configure multiple windows according to the placement state.

For example, when the portable electronic device 100 faces a forward direction relative to the user's face and is horizontally placed on the ground, the controller 160 may configure multiple windows placed vertically with respect to the touch screen 120. However, the configuration of the multiple windows is only an example, and does not limit the scope of the present invention. Accordingly, the controller 160 may control the multiple windows to be configured according to a predetermined user setting regardless of the placement state of the portable electronic device 100. For example, when the portable electronic device 100 faces a forward direction relative to the user's face and is horizontally placed on the ground, the controller 160 may configure multiple windows horizontally with respect to the touch screen 120.

In step S209, the controller 160 can control the display panel 123 to display function execution screens corresponding to the plurality of objects through the multiple windows configured in step S207. When screens in which functions corresponding to the plurality of objects are executed through the multiple windows are displayed, the controller 160 can control the display panel 123 to display separators for separating the multiple windows and controlling sizes of the multiple windows. For example, when the multiple windows are configured by two windows, the controller 160 can control the display panel 123 to display one separator between the two windows to separate the two windows. The controller 160 can detect a touch gesture for the separator, for example, a touch drag gesture for the separator and control each of the sizes of the multiple windows according to a direction of the touch drag.

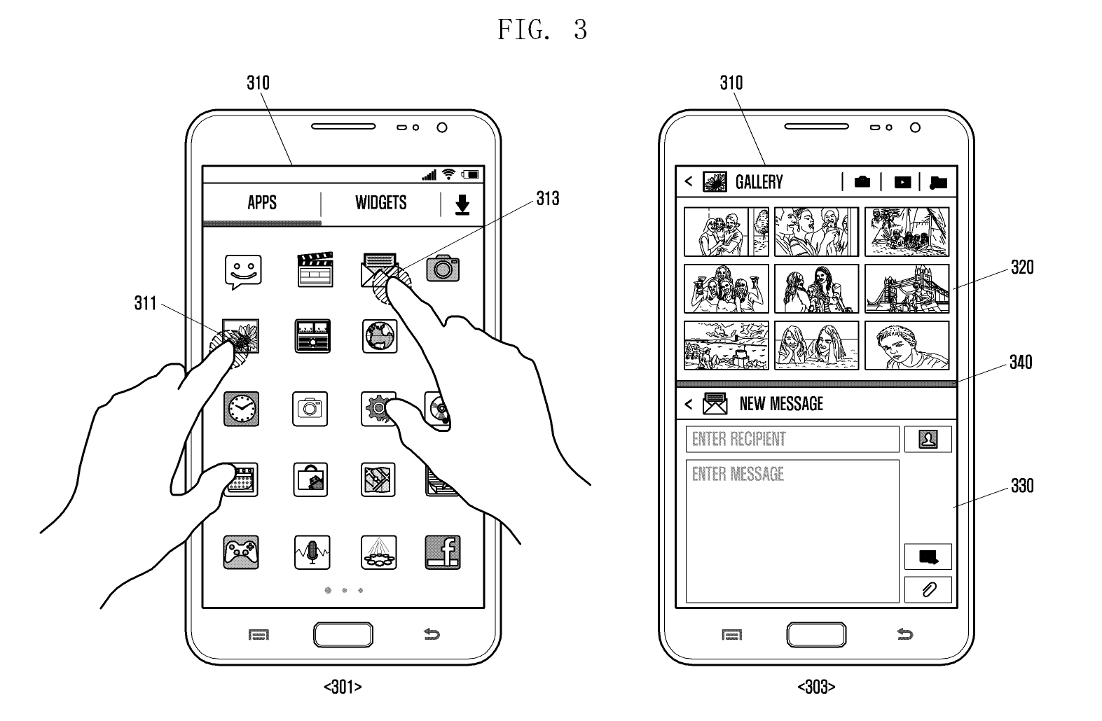

FIG. 3 illustrates a method of executing a multi-window function according to an embodiment of the present invention.

Referring to FIG. 3, reference numeral 301 indicates a touch screen 310 which includes the plurality of objects. When a plurality of objects, for example, a gallery icon 311 and a message icon 313, are displayed when a multi-touch gesture for the gallery icon 311 and the message icon 313 is input, the controller 160 can display function execution screens corresponding to the gallery icon 311 and the message icon 313 through a first window 320 and a second window 330 as shown in screen 303. The multi-touch gesture may be a multi-touch or a long-tap for the gallery icon 311 and the message icon 313. When the portable electronic device 100 faces a forward direction relative to the user's face and is vertically located as shown in the screens 301 and 303, touch screen 310 is split into two screens vertically from the touch screen 120, generating the first window 320 and the second window 330. However, the placement of the multiple windows is not limited thereto, and may be configured according to a designer's intention or a user's intention.

The controller 160 can control the display panel 123 to display a separator 340. In other words, as shown in the screen 303, the controller 160 can control the display panel 123 to display the separator 340 to separate, and to control sizes of, the first window 320 and the second window 330.

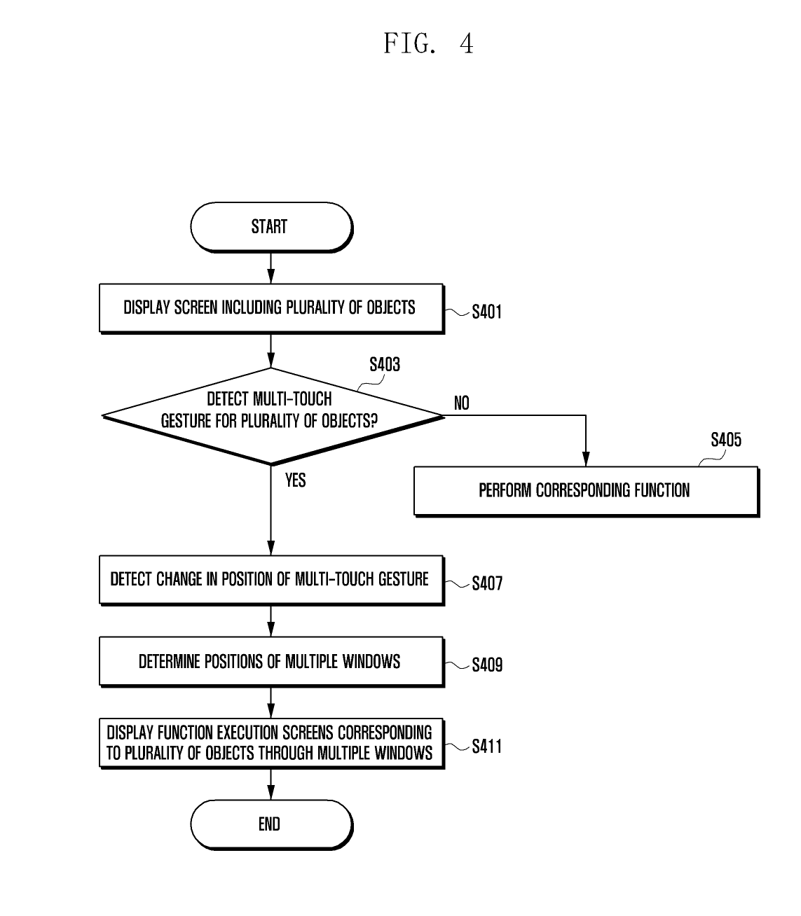

FIG. 4 is a flowchart illustrating the method of executing the multi-window function according to another embodiment of the present invention.

Referring to FIG. 4, the controller 160 can control the display panel 123 to display screens including a plurality of objects in step S401. The screens can include a home screen, a menu screen, and an application execution screen including a plurality of objects.

In step S403, the controller 160 can identify whether a multi-touch gesture for a plurality of objects is detected. More specifically, when a multi-touch gesture for a plurality of objects displayed on the touch screen 120 is detected, the controller 160 can receive a multi-touch event from the touch panel 121. The controller 160 can detect the multi-touch gesture from the received multi-touch event. Unlike the multi-touch gesture which corresponds to the multi-touch or the multi-long tap in step S203, the multi-touch gesture can be a multi-touch drag or a multi-touch flick in step S403. In other words, the multi-touch gesture can be a touch input of moving a finger when a touch on the touch screen 120 is maintained, such as the multi-touch drag or the multi-touch flick.

When it is identified that the multi-touch gesture for the plurality of objects is not detected in step S403 or when a touch event for executing a function other than the touch event for executing the multi-window function is received, the controller 160 can perform a control to execute a function corresponding to the touch event in step S405.

When it is identified that the multi-touch gesture for the plurality of objects is detected in step S403, the controller 160 can detect a change in a position of the multi-touch gesture in step S407. More specifically, the controller 160 can detect a change in a position of the multi-touch gesture such as positions at which multiple touches start and movement directions thereof based on the multi-touch event received from the touch panel 121.

In step S409, the controller 160 can determine positions of the multiple windows based on the detected multi-touch gesture. For example, when a plurality of objects including a first object and a second object are displayed on the touch screen 120, when the first object is dragged towards an upper part of the touch screen 120 and the second object is dragged towards a lower part of the touch screen 120, the controller 160 horizontally splits the touch screen 120 into two screens, so that the two windows can be vertically located on the touch screen 120. When the first object is dragged towards the right side of the touch screen 120 and the second object is dragged towards the left side of the touch screen 120, the controller 160 can vertically split the touch screen 120 into two screens and place the two windows on right and left sides of the touch screen 120.

In step S411, when positions of the multiple windows are determined in step S409, the controller 160 can control the display panel 123 to display function execution screens corresponding to the plurality of objects through the multiple windows placed on the determined positions in step S409.

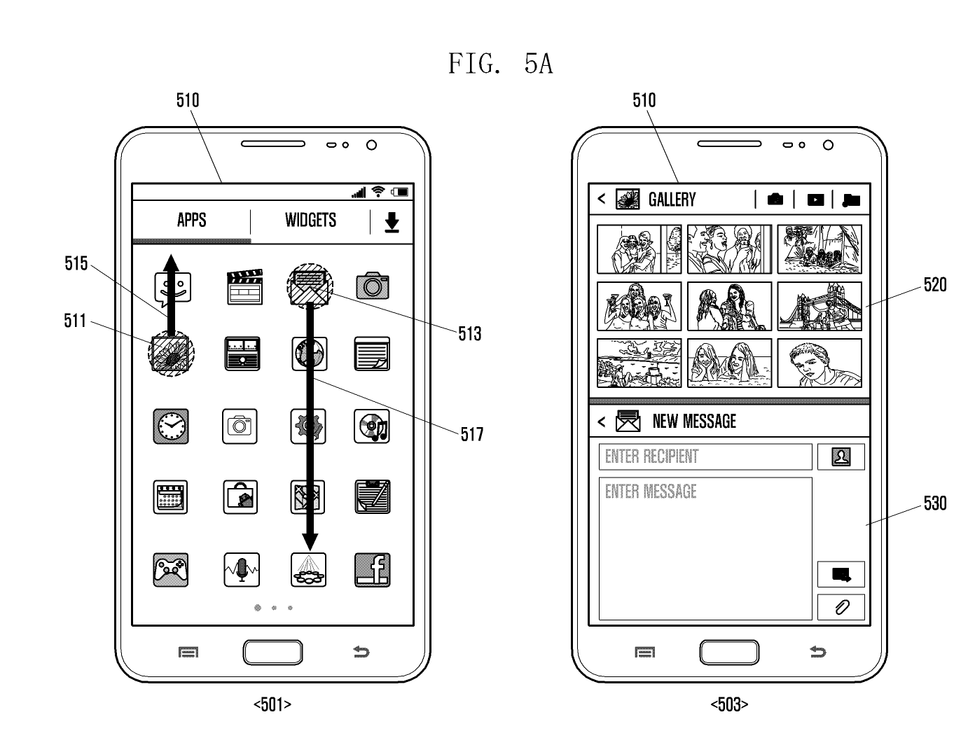

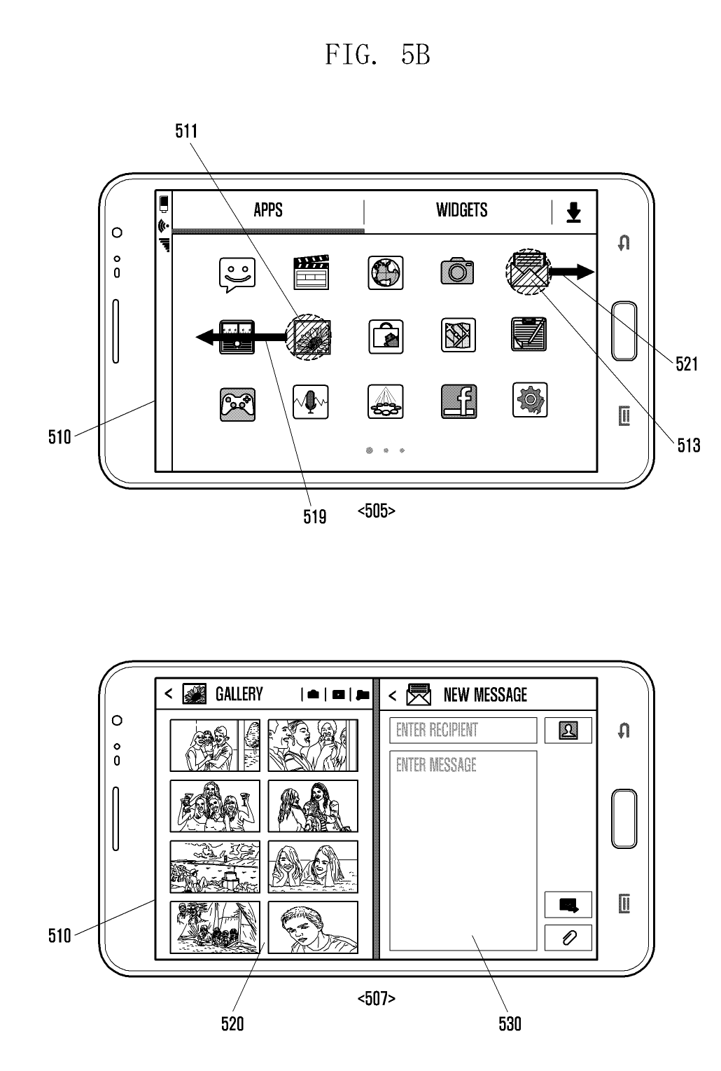

FIGS. 5A and 5B illustrate examples for describing the method of executing the multi-window function according to another embodiment of the present invention.

Referring to FIGS. 5A and 5B, a screen 501 including a plurality of objects in the touch screen 510 is illustrated. When a plurality of objects, for example, a gallery icon 511 and a message icon 513 are displayed, and a multi-touch gesture for the gallery icon 511 and the message icon 513 is input, the controller 160 can display function execution screens corresponding to the gallery icon 511 and the message icon 513 through a first window 520 and a second window 530 as shown in touch screen 510.

More specifically, in screen 501, the user can perform a multi-touch drag (or a multi-touch flick) on the gallery icon 511 and the message icon 517. The multi-touch drag for the gallery icon 511 can be made in an upward direction of the touch screen 120 as indicated by arrow 515 and the multi-touch drag for the message icon 513 can be made in a downward direction of the touch screen 510. The controller 160 can control the display panel 123 to display a function execution screen corresponding to the gallery icon 511 in an upper part of the touch screen 510 of the touch screen 510 and to display a function execution screen corresponding to the message icon 513 in a lower part of the touch screen 510 as shown in screen 503.

The controller 160 can perform a control to execute the multi-window function according to a placement state of the portable electronic device 100 and a movement direction of the received multi-touch gesture. For example, when the portable electronic device 100 is vertically located in a forward direction relative to the user's face as shown in screen 501, the multi-touch drag is performed on the gallery icon 511 and the message icon 513 in an upward direction and a downward direction of the touch screen 510. Thus, the touch screen 120 is horizontally split into multiple windows as shown in screen 503, so that function execution screens corresponding to the gallery icon 511 and the message icon 513 can be output through the multiple windows.

In FIG. 5B, when the portable electronic device 100 is horizontally located in a forward direction relative to the user's face as shown in screen 505, the multi-touch drag is performed on the gallery icon 511 and the message icon 513 towards the left side of the touch screen along arrow 519 and towards the right side of the touch screen 510 along arrow 521. Thus, the touch screen 510 is vertically split into multiple windows as shown in screen 507, so that function execution screens corresponding to the gallery icon 511 and the message icon 513 can be output through the multiple windows.

As described above, in an embodiment of the present invention, the controller 160 can perform a control to place the multiple windows according to directions of the multi-touch gesture, and execute the multi-window functions only when a multi-touch drag in a particular preset direction is detected. For example, when the portable electronic device 100 is vertically located in a forward direction relative to the user's face, and a multi-touch drag is made in a direction other than the multi-touch drag in the upward direction or the downward direction of the touch screen 510, the controller 160 can perform a control not to execute the multi-window function. Similarly, when the portable electronic device 100 is horizontally located in a forward direction relative to the user's face as shown in screen 505, when a multi-touch drag is made in a direction other than the multi-touch drag towards the left side or the right side of the touch screen 510, the controller 160 can perform a control not to execute the multi-window function.

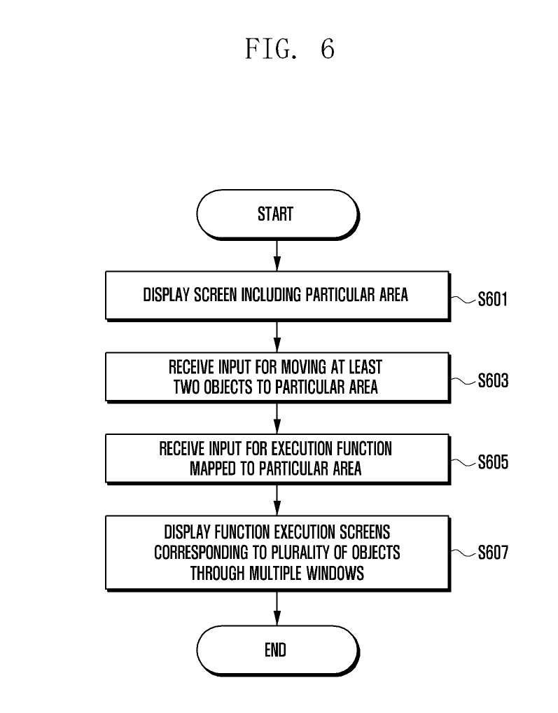

FIG. 6 is a flowchart illustrating the method of executing the multi-window function according to another embodiment of the present invention.

Referring to FIG. 6, the controller 160 can display screens including particular areas for executing multi-window functions in step S601. The particular areas may be displayed in the form of box in one side of the screen which does not overlap an object displayed on the screen. In some embodiments, the controller 160 can control the display panel 123 to be output only when there is a multi-window activation mode input in the particular area.

In step S603, the controller 160 can detect a touch gesture for moving an object to a particular area. The touch gesture can include not only a multi-touch gesture simultaneously input for at least two objects, but also a touch drag for one of the objects sequentially input. For example, when a home screen including a first object and a second object is currently displayed on the touch screen 120, the first object and the second object can be moved to particular areas through the multi-touch drag. When the home screen is configured by a plurality of pages, the first object is displayed on a first page of the home screen, and the second object is displayed on a second page of the home screen, the controller 160 can perform a touch drag on the first object to move the first object to a particular area when the first page of the home screen is displayed, and can perform a touch drag on the second object to move the second object to a particular area when the second page of the home screen is displayed.

When the object is moved to the particular area, the controller 160 can control the display panel 123 to display the particular area and the object included in the particular area so that the user can see the object included in the particular area. When the object is moved to the particular area and thus included in the particular area, the object is reduced in size and is displayed.

In step S605, the controller 160 can receive an input for executing a function mapped to the particular area. For example, when the controller 160 receives a touch input for the particular area from the user, the controller 160 may configure the number of multiple windows corresponding to the number of objects included in the particular area. In step S607, the controller 160 can display function execution screens corresponding to a plurality of objects through the multiple windows.

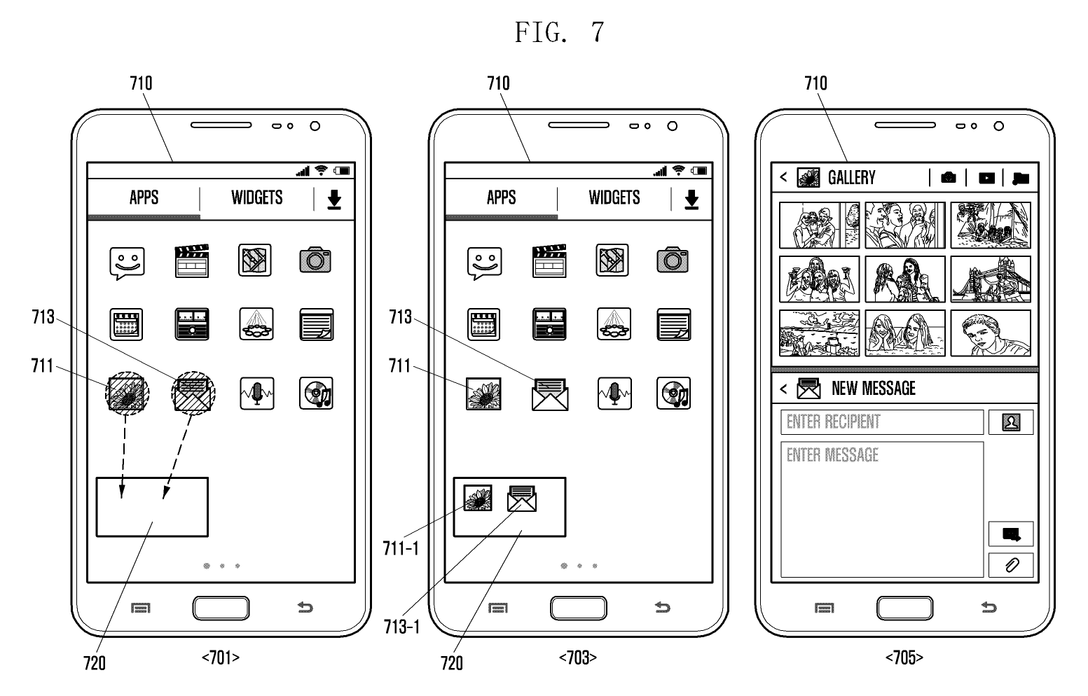

FIG. 7 illustrates a method of executing the multi-window function according to another embodiment of the present invention.

Referring to FIG. 7, as indicated by reference numeral 701, a touch screen 710 includes a particular area 720, a gallery icon 711, and a message icon 713. The user may move the gallery icon 711 and the message icon 713 to the particular area 720 by performing a multi-touch drag or sequential touch drags on the gallery icon 711 and the message icon 713.

As indicated by screen 703, a touch screen 710 is displayed when the gallery icon 711 and the message icon 713 are dragged within the particular area 720. When the gallery icon 711 and the message icon 713 are included in the particular area 720, the controller 160 can control the display panel 123 to display a gallery icon 711-1 and a message icon 713-1 reduced from the gallery icon 711 and the message icon 713 within the particular area 720.

When the user touches the particular area 720 or inputs a key for executing a function mapped to the particular area 720 in screen 703, the controller 160 can control the display panel 123 to display function execution screens corresponding to the gallery icon 711 and the message icon 713 in screen 705.

FIG. 7 describes an example of executing the multi-window functions by performing the multi-touch gesture or the touch gesture on icons displayed on one screen to move the icons to the particular area. In contrast, when a home screen includes a plurality of pages, the gallery icon 711 is currently displayed on a screen corresponding to a first page, and the message icon 713 is displayed on a screen corresponding to a second page, the user may move the gallery icon 711 to the particular area, switch the page to a different page, and then move the message icon included in the different page to the particular area 720.

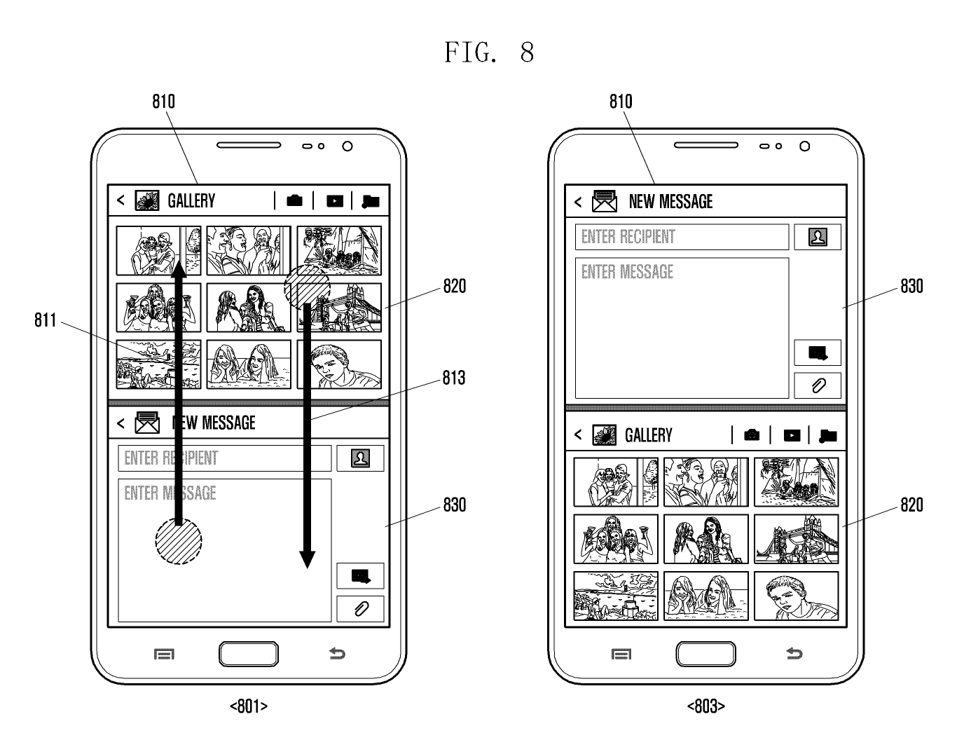

FIG. 8 illustrates multi-window switching according to an embodiment of the present invention.

Referring to FIG. 8, reference numeral 801 indicates a screen in which a first window 820 displaying a gallery execution screen on an upper part of a touch screen 810 is located and a second window 830 displaying a message execution screen on a lower part of the touch screen 910 is located. When the user performs a touch drag on the first window 820 in a downward direction of the touch screen 810 as indicated by an arrow 811 and a touch drag on the second window 830 in an upward direction of the touch screen 810 as indicated by an arrow 813, the controller 160 can perform a control to move the first window 820 to a lower part of the touch screen 810 where the second window 830 was located and move the second window 830 to an upper part of the touch screen 810 where the first window was located.

The controller 160 may switch positions of the multiple windows by a touch gesture for only one of the multiple windows as well as the multi-touch gesture. For example, when the user touches and drags one position of the first window 820 and ends the drag in the second window 830, the controller 160 can perform a control to switch the positions of the first window 820 and the second window 830. When the first window 820 and the second window 830 switch in the screen 801, the second window 830 can be placed on the upper part of the touch screen 810 and the first window 820 can be placed on the lower part of the touch screen 810.

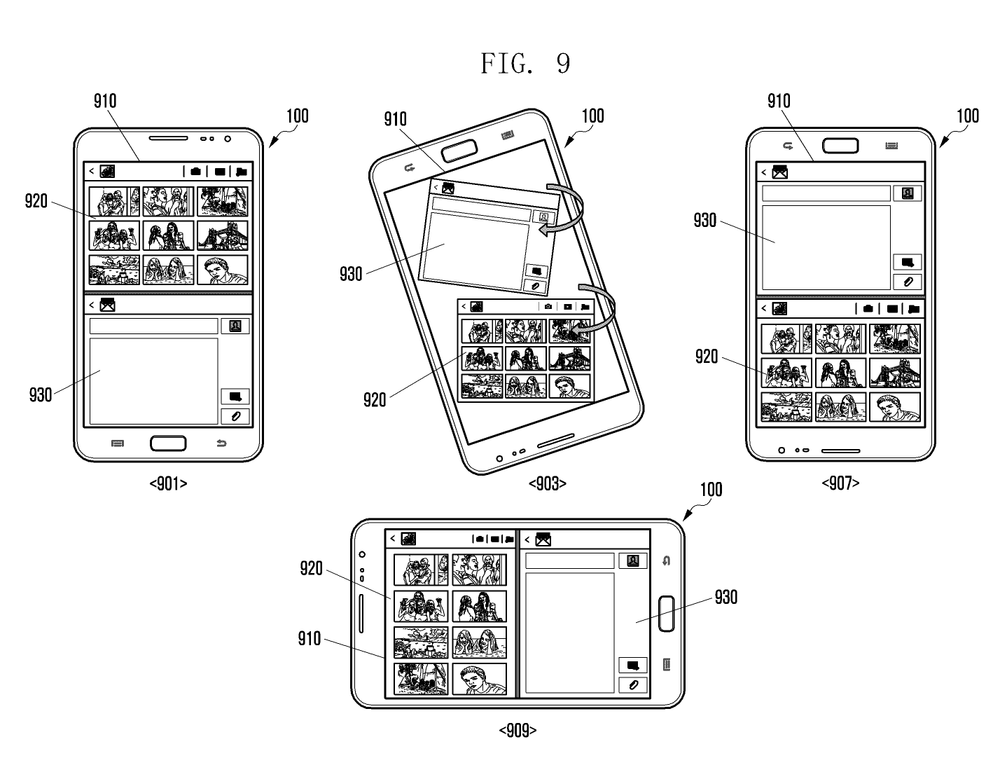

FIG. 9 illustrates a multi-window movement by a rotation of the portable electronic device according to an embodiment of the present invention.

Referring to FIG. 9, reference numeral 901 indicates a screen in which a first window 920 displaying a gallery execution screen on an upper part of a touch screen 910 is located and a second window 930 displaying a message execution screen on a lower part of the touch screen 910 is located.

As shown in a screen 903, when the portable electronic device 100 rotates, the touch screen 910 is displayed as shown in screen 907 or 909 according to a rotation direction and a rotation angle. Screen 907 illustrates when the portable electronic device 100 rotates by 180 degrees when the portable electronic device 100 is vertically located relative to the user's face, and multiple windows horizontally split from the touch screen are placed. Based on the rotation information received by the sensor unit 140, the controller 160 can place the multiple windows vertically with respect to the touch screen 910.

As shown in screen 907, positions of the first window 920 and the second window 930 can be switched with each other. However, the scope of the present invention is not limited thereto. When the portable electronic device 100 rotates by 180 degrees, the positions of the first window 920 and the second window 930 may not change. For example, even when the portable electronic device 100 rotates by 180 degrees when the multiple windows are located as shown in the screen 901, the state where the first window 920 is located in the upper part of the touch screen 120 and the second window 930 is located in the lower part of the touch screen 120 can be maintained.

Screen 909 illustrates when the portable electronic device 100 rotates by 90 degrees when the portable electronic device 100 is placed and multiple windows are arranged as shown in screen 901. As shown in screen 909, the first window 920 can be located on the left side of the touch screen 910 and the second window 930 can be located on the right side of the touch screen 910. The first window 920 and the second window 930 can be vertically split with respect to the touch screen 910.

As described above, the method of controlling the screen of the portable electronic device 100 according to various embodiments of the present invention can provide excellent utility by executing the multi-window function through a simple touch gesture and supporting the display of multiple windows on positions which the user desires.

The portable electronic device 100 may further include various and additional modules according to the provided form thereof. That is, the portable electronic device may further include components which have not been mentioned, such as a short-range communication module for short-range communication, an interface for data transmission/reception of the portable electronic device 100 by a wired communication scheme or a wireless communication scheme, an Internet communication module communicating an Internet network to perform an Internet function, and a digital broadcasting module performing a digital broadcast receiving and reproducing function. These elements may be variously modified according to the convergence trend of digital devices, and cannot be all enumerated. However, the electronic device 100 may further include elements equivalent to the above-described elements. Also, in the portable terminal 100, a particular configuration may be excluded from the above-described configuration or may be replaced by another configuration according to embodiments of the present invention. This may be easily understood by those skilled in the art to which the present disclosure pertains.

Although embodiments of the present invention have been shown and described in this specification and the drawings, they are used in general sense in order to easily explain technical contents of the present invention, and to help comprehension of the present invention, and are not intended to limit the scope of the present invention. It is obvious to those skilled in the art to which the present invention pertains that other modified embodiments on the basis of the spirit and scope of the present invention besides the embodiments disclosed herein can be performed.

What is claimed is:

1. A method of controlling a screen of a portable electronic device, the method comprising:
detecting touch gestures simultaneously input for a plurality of objects displayed on a touch screen;
configuring a plurality of windows based on the detected touch gestures; and
displaying function execution screens corresponding to the plurality of objects through the plurality of configured windows.

2. The method of claim 1, wherein the touch gesture is one of a touch or a long tap.

3. The method of claim 1, wherein configuring the plurality of windows comprises determining positions of the plurality of windows according to a placement state of the portable electronic device.

4. The method of claim 1, wherein detecting the touch gestures comprises detecting a change in positions of the touch gestures, wherein configuring the plurality of windows comprises determining positions of the plurality of windows on the touch screen according to the detected change in the positions of the touch gestures, and wherein displaying the function execution screens comprises displaying the function execution screens on the determined positions.

5. The method of claim 4, wherein determining the positions of the plurality of windows on the touch screen comprises determining the positions of the plurality of windows on the touch screen only when the touch gesture is moved in a preset direction according to a placement state of the portable electronic device.

6. The method of claim 1, further comprising outputting a separator for separating the plurality of windows and controlling a size of each of the plurality of windows.

7. The method of claim 1, further comprising:
receiving an input for switching positions of the plurality of windows if the function execution screens corresponding to the plurality of objects are displayed through the plurality of windows; and
displaying the function execution screens corresponding to the plurality of objects through the plurality of windows of which the positions are switched.

8. The method of claim 1, further comprising, when the portable electronic device rotates if the function execution screens corresponding to the plurality of objects are displayed through the plurality of windows, moving positions of the plurality of windows according to a rotation direction of the portable electronic device.

9. A method of controlling a screen of a portable electronic device, the method comprising:
displaying an area for executing a multi-window function;
sequentially or simultaneously moving a plurality of objects to the area;
receiving an input for activating a function corresponding to the area;
configuring a plurality of windows based on the received input; and
displaying function execution screens corresponding to the plurality of objects through the plurality of configured windows.

10. The method of claim 9, further comprising, when the plurality of objects are moved to the area, displaying a plurality of objects in a reduced size from the plurality of objects within the area.

11. A portable electronic device, comprising:
a touch screen configured to display a plurality of objects and to detect touch gestures simultaneously input for the plurality of objects; and
a controller configured to detect the touch gestures input into the touch screen, to configure a plurality of windows based on the detected touch gestures, and to control the touch screen to display function execution screens corresponding to the plurality of objects through the plurality of configured windows.

12. The portable electronic device of claim 11, wherein the touch gesture is one of a touch or a long tap.

13. The portable electronic device of claim 11, wherein the controller further configured to determine positions of the plurality of windows according to a placement state of the portable electronic device to configure the plurality of windows.

14. The portable electronic device of claim 11, wherein the controller further configured to detect a change in positions of the touch gestures, to perform a control to determine positions of the plurality of windows on the touch screen according to the detected change in the positions of the touch gestures, and to control the touch screen to display the function execution screens corresponding to the plurality of objects through the plurality of configured windows on the determined positions.

15. The portable electronic device of claim 14, wherein the controller further configured to determine the positions of the plurality of windows on the touch screen only when the touch gesture is moved in a preset direction according to a placement state of the portable electronic device.

16. The portable electronic device of claim 11, wherein the controller further configured to control the touch screen to output a separator for separating the plurality of windows and controlling a size of each of the plurality of windows.

17. The portable electronic device of claim 11, wherein the touch screen further configured to receive an input for switching positions of the plurality of windows if the function execution screens corresponding to the plurality of objects are displayed through the plurality of windows, and the controller further configued to control the touch screen to display the function execution screens corresponding to the plurality of objects through the plurality of windows of which the positions are switched.

18. The portable electronic device of claim 11, further comprising a sensor unit configured to detect a rotation of the portable electronic device, wherein, when the controller receives rotation information of the portable electronic device from the sensor unit if the function execution screens corresponding to the plurality of objects are displayed through the plurality of windows, the controller further configured to control to move positions of the plurality of windows according to a rotation direction of the portable electronic device.

19. The portable electronic device of claim 11, wherein the controller further configured to control the touch screen to display an area for executing a multi-window function, sequentially or simultaneously to move the plurality of objects to the area, to receive an input for activating a function corresponding to the area, to configure a plurality of windows based on the received input, and to control the touch screen to display the function execution screens corresponding to the plurality of objects through the plurality of configured windows.

20. The electronic device of claim 19, wherein, when the plurality of objects are moved to the area, the controller further configured to control the touch screen to display a plurality of objects in a reduced size from the plurality of objects within the area.
